(19) United States
(12) Patent Application Publication
(10) Pub. No.: US 2015/0127377 A1
(43) Pub. Date: May 7, 2015

(54) COLOR MATCHING FOR HEALTH MANAGEMENT

(71) Applicant: A.T. Still University, Mesa, AZ (US)

(72) Inventor: Shervin Tony Hashemian, Scottsdale, AZ (US)

(21) Appl. No.: 14/480,326

(22) Filed: Sep. 8, 2014

Related U.S. Application Data
(60) Provisional application No. 61/901,344, filed on Nov. 7, 2013.
(60) Provisional application No. 61/927,625, filed on Jan. 15, 2014.

(51) Int. Cl. G06F 19/00

(52) U.S. Cl. CPC G06F 19/3487; G06F 19/322
USPC 705/3

(57) ABSTRACT

Information may be stored regarding a plurality of colors that are each associated with a pH level. In addition, one or more patient records may be stored regarding a pH level for each of a plurality of samples from a patient over time. An electronic indication regarding a color associated with a sample from the patient may be received via a communication interface. The received electronic indication regarding the color may be compared with the stored information in memory regarding the plurality of colors. A closest match between the received electronic indication and one of the plurality of colors in memory may be identified. A pH associated with the closest matching color may be determined. Further, a patient record associated with the received electronic indication may be updated to include the determined pH and the closest matching color.

### CROSS-REFERENCE TO RELATED APPLICATIONS

The present patent application claims the priority benefit of U.S. provisional patent application 61/901,344 filed on Nov. 7, 2013 and U.S. provisional patent application 61/927,625 filed on Jan. 15, 2014, the disclosures of which are incorporated herein by reference.

### BACKGROUND

1. Field of the Invention

The present invention generally relates to health management. More specifically, the present invention relates to color matching for health management.

2. Description of the Related Art

Many substances may be characterized by its pH (e.g., a measure of how acidic or basic a substance is). A pH level of a substance may change, however, in response to certain circumstances. Such changes in acidity or alkalinity of a patient's bodily fluids may be a risk factor or may otherwise indicate a change that may have an effect on health.

For example, the oral cavity is the gateway and window into the health of the human body. Signs of nutritional deficiencies, general infections, and systemic diseases that affect the entire body may first become apparent in the oral cavity via lesions or other oral problems. Saliva plays a significant role in maintaining oral health, and low PH level has a strong correlation to tooth decay and other systemic conditions. Increase of intraoral acidity usually brings forth dental disease, caries, and erosion. Ongoing studies indicate that saliva may also be useful for detecting various cancers, including breast and oral cancers, heart disease, diabetes, periodontal and gum diseases, viral hepatitis and other conditions. Saliva is already used for rapid HIV testing, for example.

While saliva is an exemplary body fluid that may be tested for pH, a variety of other bodily substances (e.g., urine, blood, sweat, tears, skin oils) may also be tested for pH as well. The pH of such other bodily substances may be indicative of symptoms, risk, or otherwise related or linked to certain health conditions. As such, the present invention may be used with any bodily substance that may be characterized by pH that may be indicative of a health condition.

This science and technology initiative is to increase valuable information for oral health and to potentially improve health and quality of life for the global community through a cost-effective, innovative solution.

### SUMMARY OF THE CLAIMED INVENTION

Embodiments of the present invention deliver new technologies for patient sample pH testing. Information may be stored regarding a plurality of colors that are each associated with a pH level. In addition, one or more patient records may be stored regarding a pH level for each of a plurality of samples from a patient over time. An electronic indication regarding a color associated with a sample from the patient may be received via a communication interface. The received electronic indication regarding the color may be compared with the stored information in memory regarding the plurality of colors. A closest match between the received electronic indication and one of the plurality of colors in memory may be identified. A pH associated with the closest matching color may be determined. Further, a patient record associated with the received electronic indication may be updated to include the determined pH and the closest matching color.

Various embodiments of the present invention include methods of color matching for health management. Such methods include storing information in memory regarding a plurality of colors each associated with a pH level, storing in memory one or more patient records that each comprises a pH level for each of a plurality of samples from a patient over time, receiving via a communication interface an electronic indication regarding a color associated with a sample from an identified patient, and executing instructions stored in memory via a processor to compare the received electronic indication regarding the color with the stored information in memory regarding the plurality of colors, to identify a closest match between the received electronic indication and one of the plurality of colors in memory, to determine a pH level associated with the closest matching color, and to update a patient record associated with the identified patient of the received electronic indication, wherein the updated patient record includes the determined pH level and the closest matching color.

Further embodiments include apparatuses for color matching for health management. Such apparatuses may include memory that stores information regarding a plurality of colors each associated with a pH level and one or more patient records that each patient record include a pH level for each of a plurality of samples from a patient over time, a communication interface that receives an electronic indication regarding a color associated with a sample from the patient, and a processor that executes instructions stored in memory to compare the received electronic indication regarding the color with the stored information in memory regarding the plurality of colors, to identify a closest match between the received electronic indication and one of the plurality of colors in memory, to determine a pH level associated with the closest matching color, and to update a patient record associated with the received electronic indication, wherein the updated patient record includes the determined pH level and the closest matching color.

Embodiments of the present invention may further include non-transitory computer-readable storage media, having embodied thereon a program executable by a processor to perform methods for color matching for health management as described herein.

### BRIEF DESCRIPTION OF THE FIGURES

FIG. 1 is an exemplary screenshot of a login page.

FIG. 2 is a screenshot of an exemplary sign up form where a user may enter information.

FIG. 3 is a screenshot of an exemplary information page for a particular patient.

FIG. 4 is a screenshot of an exemplary patient list that may be used by medical, dental, or other health professionals to enter patient information.

FIG. 5 is a screenshot of an exemplary page that may be used by a user (or associated health professional) to capture electronic data indicative of pH of patient samples.

FIG. 6A is a screenshot of an exemplary camera option used to take a digital photograph (e.g., close up of colored litmus paper).

FIG. 6B is a screenshot following capture of an exemplary digital photograph of litmus paper.

FIG. 7A is a screenshot of an exemplary color wheel menu.

FIG. 7B is a screenshot of the color wheel menu of FIG. 7A that has been rotated to select an orange color, which is correlated to a pH level of 6.00.

FIG. 7C is a screenshot of the color wheel menu of FIG. 7A which further provides an option to view historical records of pH levels captured previously.

FIG. 8 is a screenshot of an exemplary table of previous pH levels, as well as the date and time at which each pH level was captured.

FIG. 9 is a screenshot of an exemplary graph that may be generated from the table of FIG. 8.

FIG. 10 is a screenshot of an exemplary interface that may be used to synchronize information between servers.

FIG. 11 illustrates an exemplary mobile device architecture 1100 that may be utilized to implement the various features and processes described herein.

### DETAILED DESCRIPTION

Embodiments of the present invention deliver new technologies for patient sample pH testing. This new innovation may involve mobile phone application to capture time sensitive data and to communicate with the server in compliance with HIPAA regulations. Sample-testing examination tool may be used by the medical or dental team to educate patients, assist in preventive treatment planning, and properly select medical or dental materials in order to initiate changes in the patient's oral hygiene. Medical or dental teams may measure patient sample pH through pH level test strips.

Litmus paper is a strip of colored paper that is soaked in a sample (e.g., saliva, urine, blood, etc.). The paper turns a different color depending upon the pH of the patient sample. Such paper may change to a color in the range of red (indicating the strong acidic state (pH<3)) to dark blue or purple (indicating the strong alkali state (pH>11)).

While litmus paper may be one inexpensive option for determining the pH of a patient sample, other embodiments are contemplated. For example, electronic devices with a pH sensor or detector (e.g., in a stylus, probe, tongue depressor, or the like) may be used to measure the pH of patient samples. Such devices may be further adapted with components that allow for wireless operation and communication, synchronization with remote databases or servers, and user interfaces.

In an exemplary embodiment, a pH level of a sample from a particular patient may be tested by the patient, by a medical or dental professional, or other administrator. As discussed above, such pH may be determined using litmus paper, electronic pH sensors, or other alternatives known in the art of measuring pH. The test results may be entered, sent, or otherwise correlated to a pH measurement. Test results may be tracked over time, which allows for generation of reports and graphs indicating trends in sample pH. As a variety of different types of samples (e.g., saliva, urine) may be tested, the reports may further track the pH trends by type.

Where the pH level is determined using litmus paper (or similar color-based measurement system), there may be a need to easily correlate the color of the litmus paper to the corresponding pH level. Embodiments of the present invention include memory storage for maintaining data regarding color and a corresponding pH level. Information regarding the litmus paper may be evaluated by generating an electronic indication corresponding to the color of the litmus paper. Such an electronic indication may include taking a digital photograph of the litmus paper or the user selecting a color from a menu (e.g., color wheel) that corresponds to the color of the litmus paper.

Where a digital photograph is taken, the captured photograph may be compared to the stored information correlating color to pH. As such, a color matching the photograph is identified, as well as the corresponding pH. Where the user selects a color from the menu or color wheel, the selected color is compared to the colors stored in memory for a match. Such a match likewise is associated with a corresponding pH.

Embodiments of the claimed system and method may be implemented in a network environment. Network environment may include a communication network, one or more user devices, one or more service providers, databases, or servers. Devices in the network environment may communicate with each other via communications network.

Communication network may be a local, proprietary network (e.g., an intranet) and/or may be a part of a larger wide-area network. The communications network may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network allows for communication between the various components of network environment.

Users may use any number of different electronic user devices, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network. User devices may also be configured to access data from other storage media, such as memory cards or disk drives as may be appropriate in the case of downloaded services. User device may include standard hardware computing components such as network and media interfaces, non-transitory computer-readable storage (memory), and processors for executing instructions that may be stored in memory.

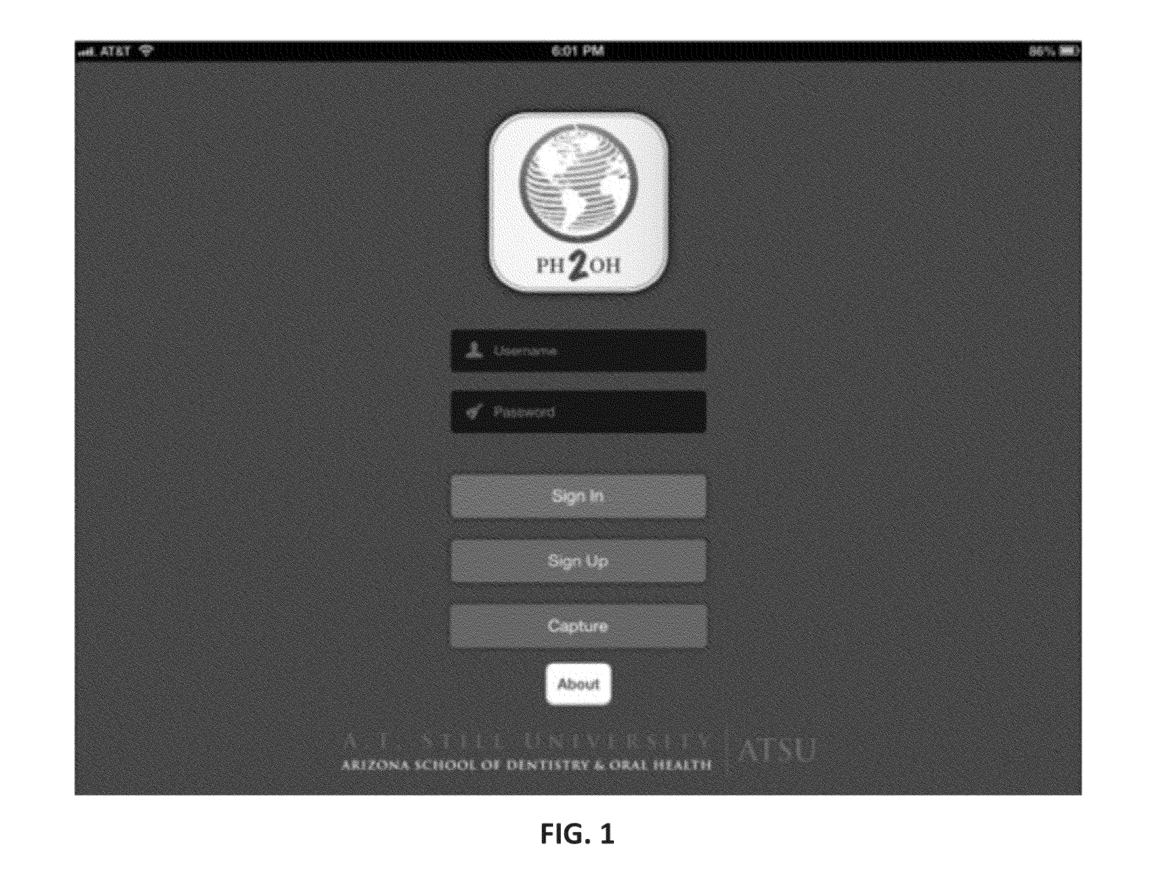

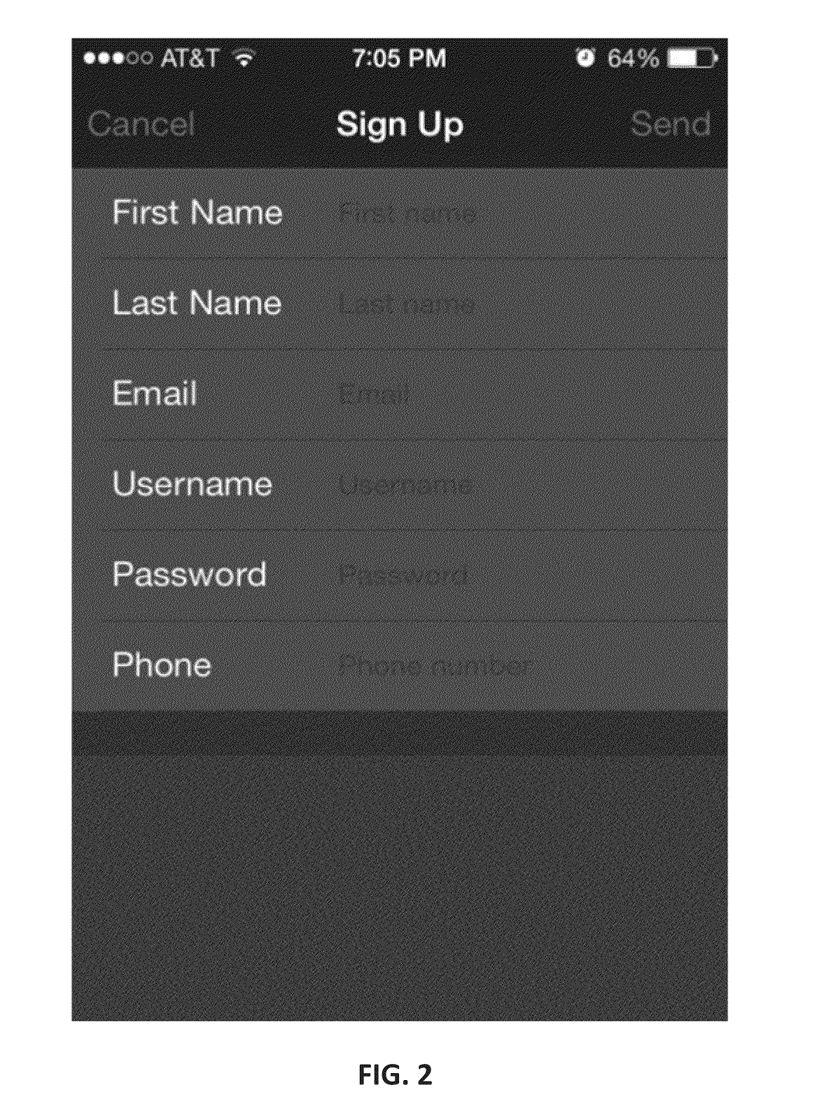

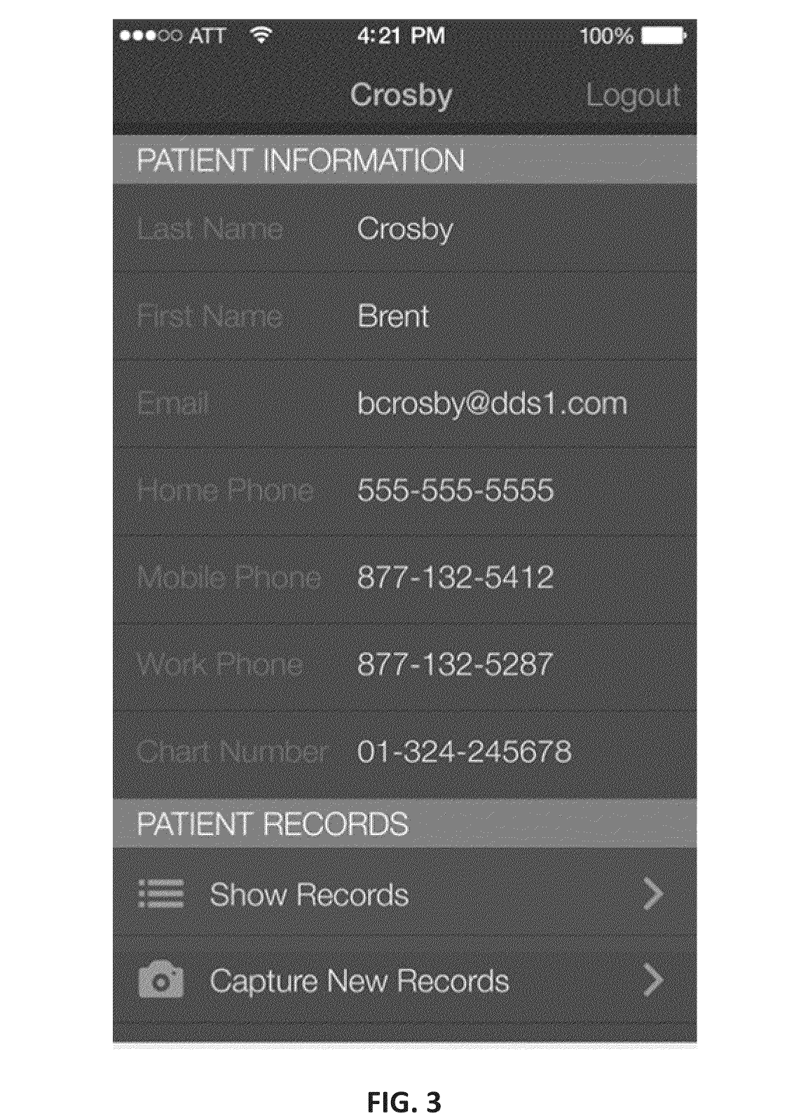

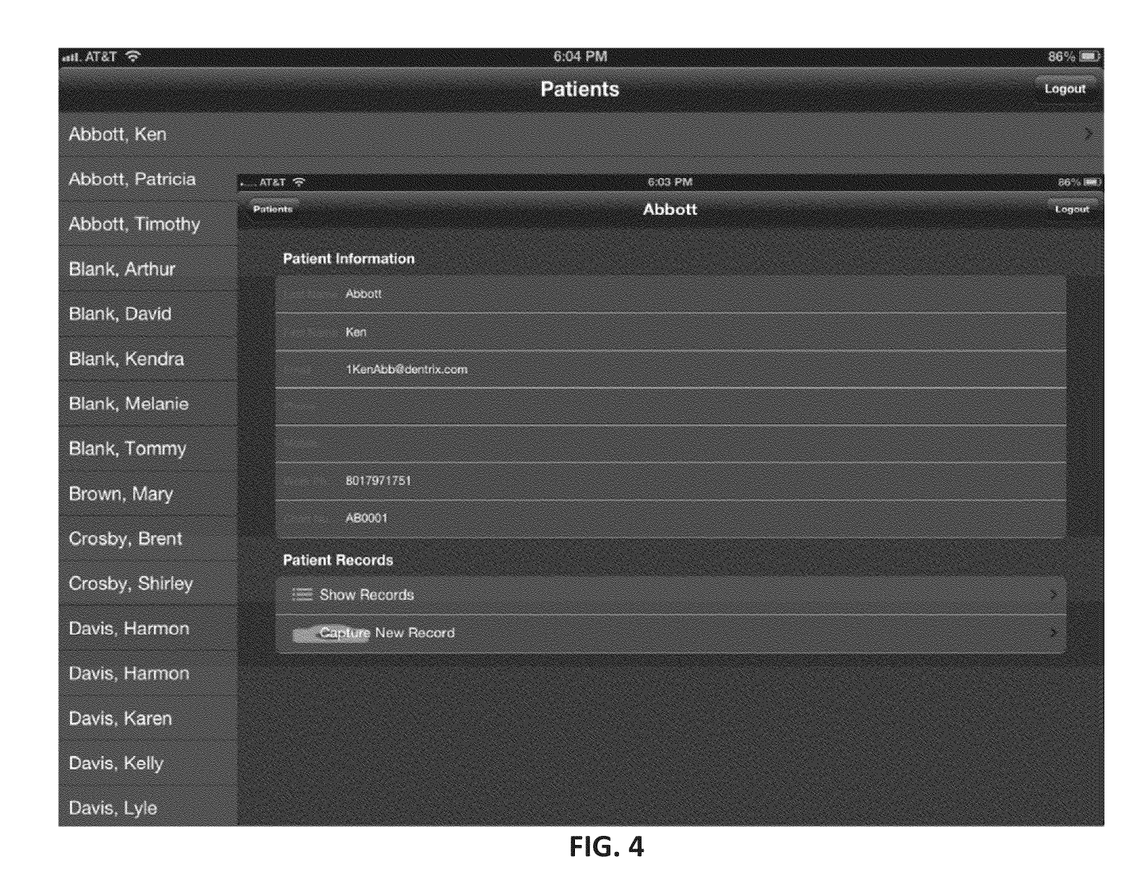

Such user devices may be able to carry out various operations described herein by downloading and installing an application (e.g., from an application store such as the App Store available on iPhone® and iPad®). Such an application may allow a user to sign in or sign up for a user account. FIG. 1 is an exemplary screenshot of a login page, with an option for sign up. FIG. 2 is a screenshot of an exemplary sign up form where a user may enter information. In some embodiments, a user may sign up for an account directly. Alternatively, a user account may be created and updated by a medical, dental, or other oral health professional, which allows for patient records to be associated with the user account. FIG. 3, for example, is a screenshot of an exemplary information page for a particular patient. Meanwhile, FIG. 4 is a screenshot of an exemplary patient list that may be used by medical, dental, or other health professionals to enter patient information.

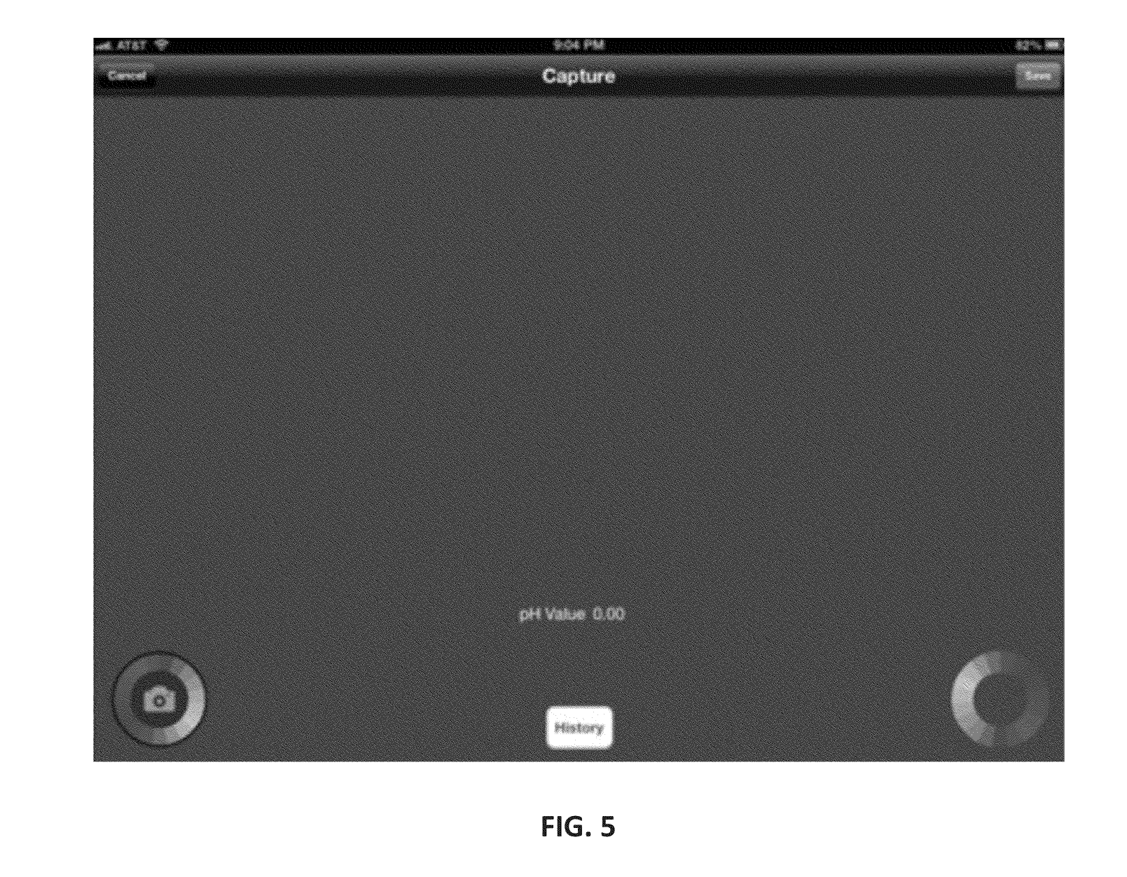

FIG. 5 is a screenshot of an exemplary page that may be used by a user (or associated health professional) to capture electronic data indicative of pH of patient samples. As can be seen, the screenshot of FIG. 5 includes two options for capturing such data: by camera or by color wheel selection. Prior to the page appearing or as an option on the page, the user (or associated health professional) may be queried as to the type of the sample (e.g., saliva, urine, or other bodily fluid) being taken. The user may selected the type from a menu, a scrollbar, or otherwise enter the requested type.

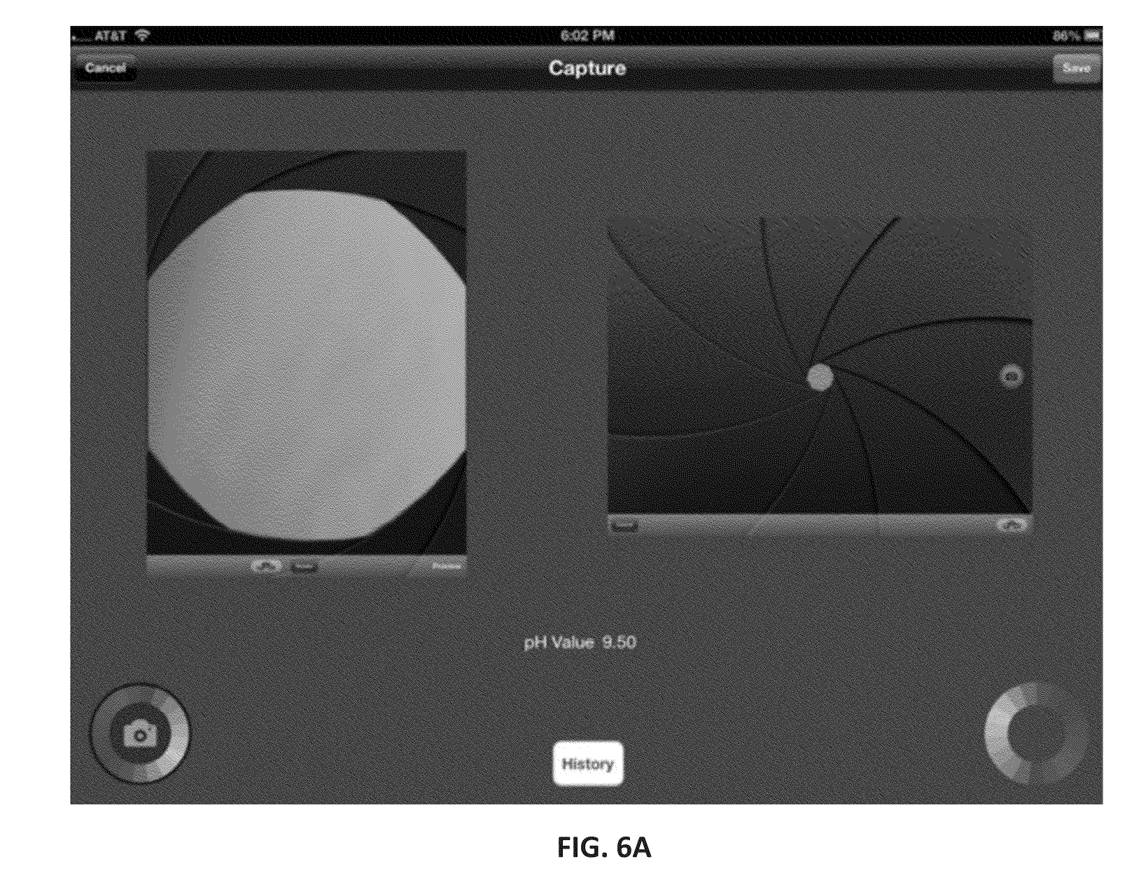

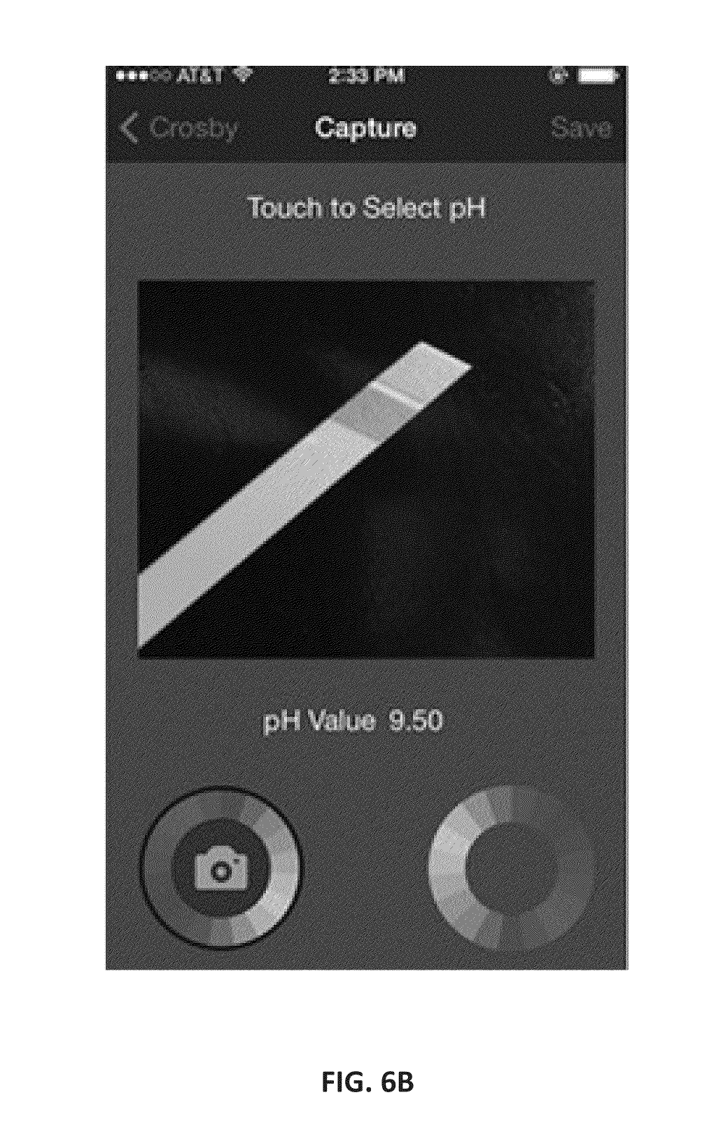

FIG. 6A is a screenshot of an exemplary camera option used to take a digital photograph (e.g., close up of colored litmus paper). As can be seen, the pH value may be updated in real-time based on matching the color in the captured digital photograph to colors stored in memory and associated with pH levels. For example, the particular color in the photograph matches a color stored in memory as being indicative of a 9.50 pH level.

FIG. 6B is a screenshot following capture of an exemplary digital photograph of litmus paper. Where the photograph may include multiple colors, the application may request that a color within the photograph be selected for evaluation. When a color is selected, it may then be matched to a color in memory and correlated to a pH level.

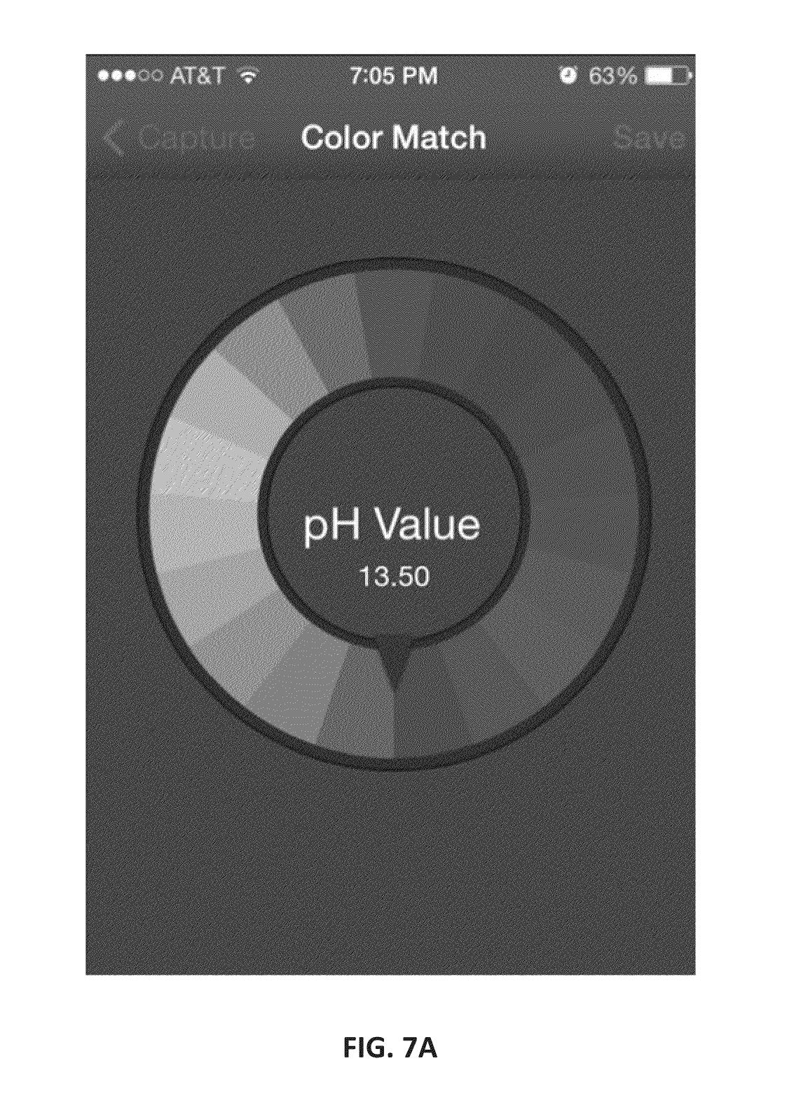

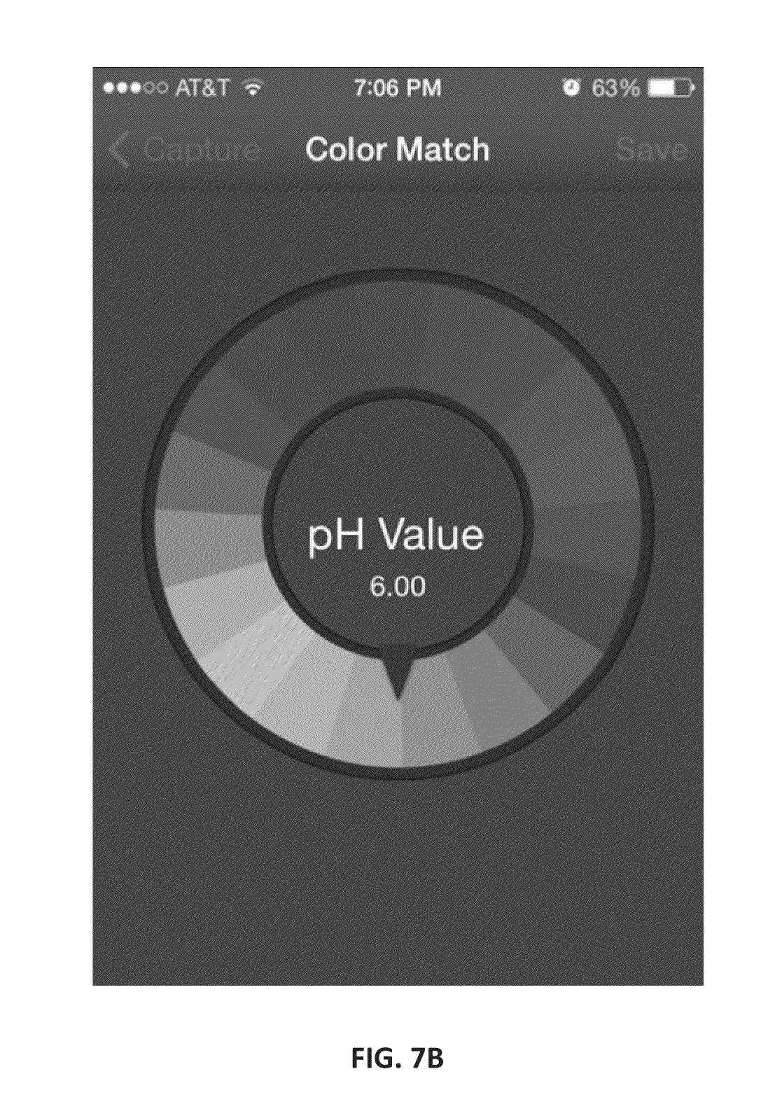

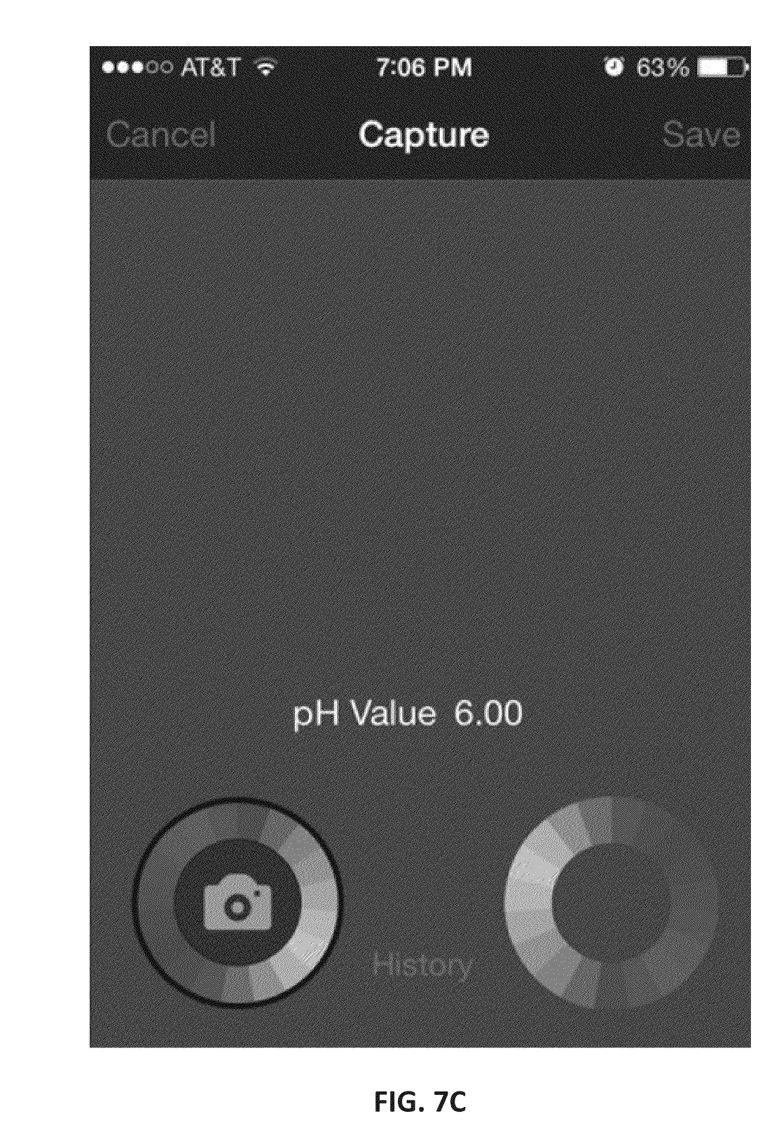

FIG. 7A is a screenshot of an exemplary color wheel menu for selecting a color. The color wheel may be rotated by the user until the pointer indicates a particular color (e.g., color of litmus paper following saliva testing). The color may be correlated to a particular pH, and the displayed “pH value” may be updated in real-time as the wheel is rotated. As illustrated in FIG. 7A, the blue color may be correlated with a pH level of 13.50. Meanwhile, FIG. 7B is a screenshot of the color wheel menu of FIG. 7A that has been rotated to select an orange color, which is correlated to a pH level of 6.00. That value may be saved as illustrated in the screenshot of FIG. 7C, which further provides an option to view historical records of pH levels captured previously.

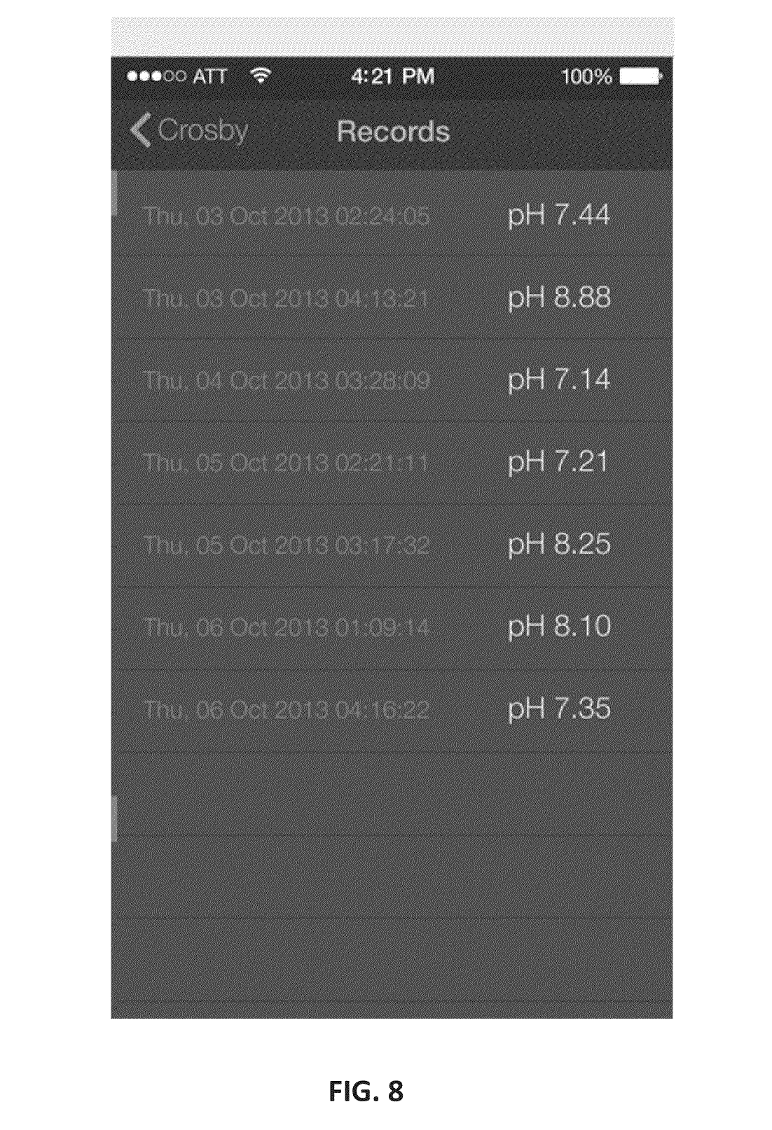

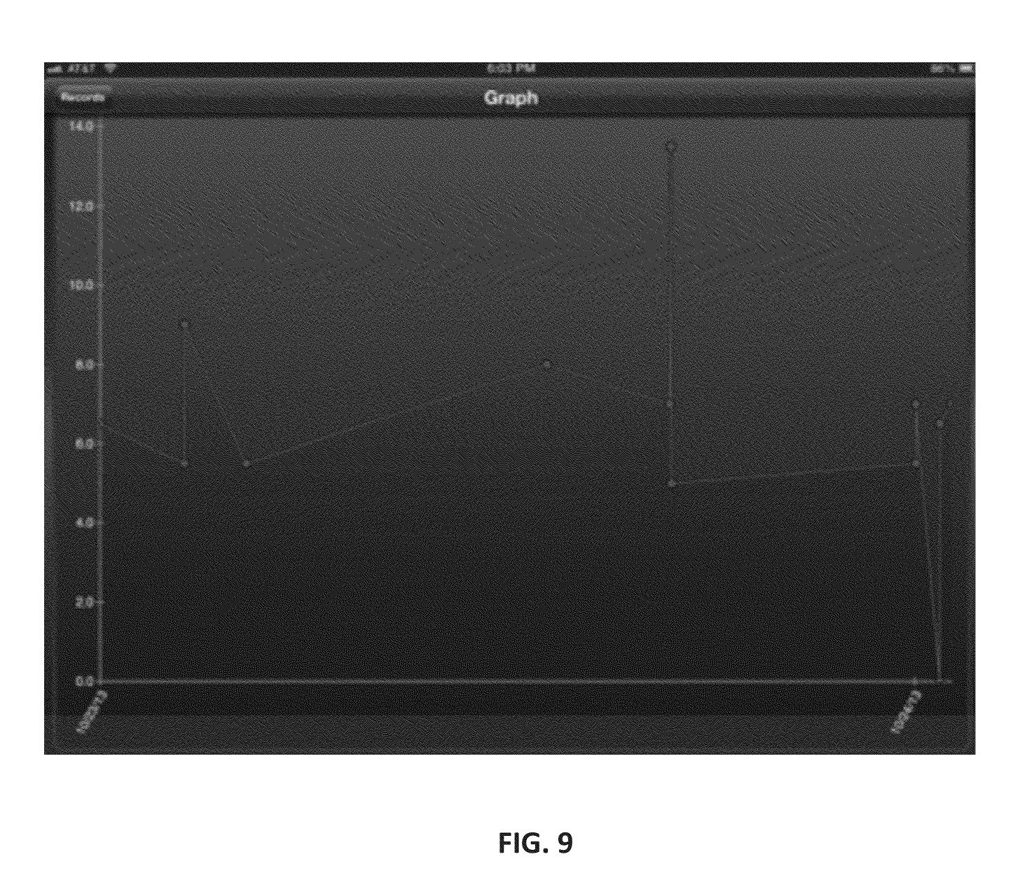

FIG. 8 is a screenshot of an exemplary table of previous pH levels, as well as the date and time at which each pH level was captured. FIG. 9 is a screenshot of an exemplary graph that may be generated from the table of FIG. 8. Such tools as described above allow a user (with or without the assistance of a medical, dentist, or other health professional) to access and maintain records regarding medical and dental health and specifically, pH of patient samples over time. Such tools may further be used to identify trends and potential issues indicated by the different pH levels captured over time. The maintained data further allows for granular analysis, as well as alerts and notifications when certain specified conditions arise.

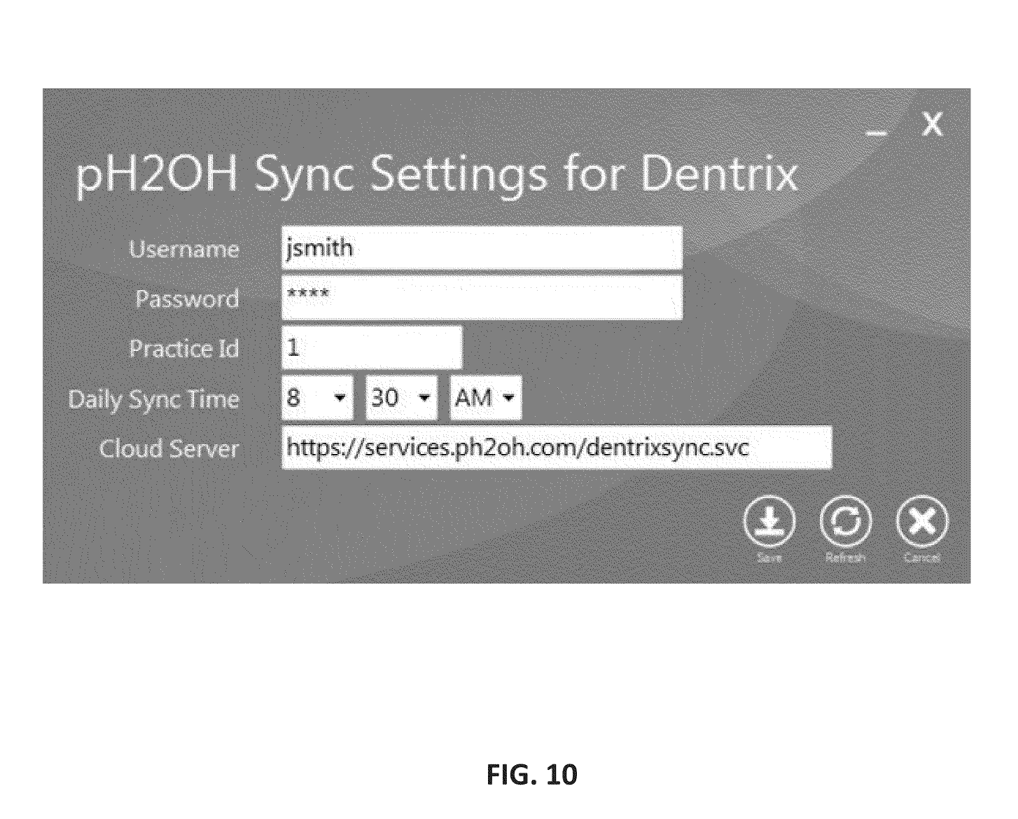

Service providers, such as medical, dental, and/or other health professionals, may enter information into any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cloud, cache, or proxy server characteristics. These characteristics may depend on the particular network placement of the server or certain configurations of the server. One common system used by service providers is the Dentrix® patient management system, which may be integrated with embodiments of the present invention. Through such integration, the health professional may allow certain records from their Dentrix® system to synchronize with the user accounts for their patients. FIG. 10 is a screenshot of an exemplary interface that may be used to synchronize information between such systems and servers.

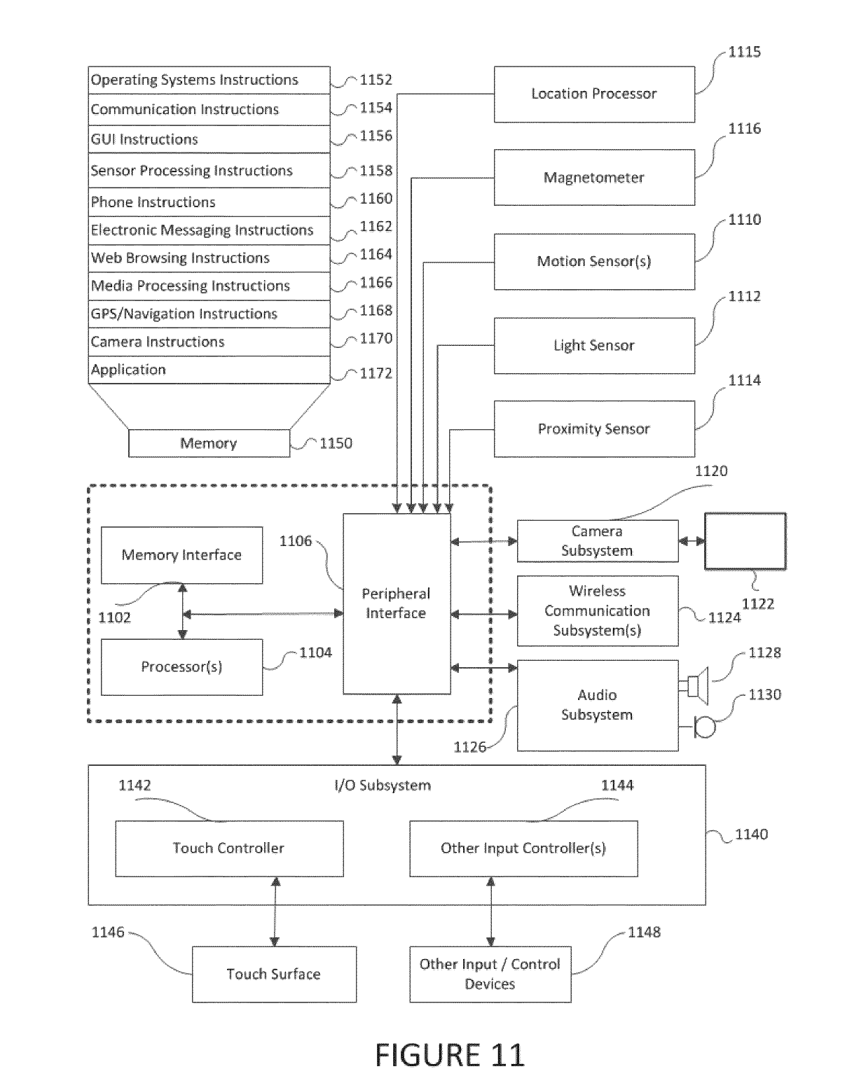

FIG. 11 illustrates an exemplary mobile device architecture 1100 that may be utilized to implement the various features and processes described herein. Architecture 1100 can be implemented in any number of portable devices including but not limited to smart phones, electronic tablets, and gaming devices. Architecture 1100 may include memory interface 1102, processors 1104, and peripheral interface 1106. Memory interface 1102, processors 1104 and peripherals interface 1106 can be separate components or can be integrated as a part of one or more integrated circuits. The various components can be coupled by one or more communication buses or signal lines.

Processors 1104 as illustrated in FIG. 11 are meant to be inclusive of data processors, image processors, central processing unit, or any variety of multi-core processing devices. Any variety of sensors, external devices, and external subsystems can be coupled to peripherals interface 1106 to facilitate any number of functionalities within the architecture 1100 of the exemplar mobile device. For example, motion sensor 1110, light sensor 1112, and pro5imity sensor 1114 can be coupled to peripherals interface 1106 to facilitate orientation, lighting, and pro5imity functions of the mobile device. For example, light sensor 1112 could be utilized to facilitate adjusting the brightness of touch surface 1146. Motion sensor 1110, which could be exemplified in the context of an accelerometer or gyroscope, could be utilized to detect movement and orientation of the mobile device. Display objects or media could then be presented according to a detected orientation (e.g., portrait or landscape).

Other sensors could be coupled to peripherals interface 1106, such as a temperature sensor, a biometric sensor, or other sensing device to facilitate corresponding functionalities. Location processor 1115 (e.g., a global positioning transceiver) can be coupled to peripherals interface 1106 to allow for generation of geo-location data thereby facilitating geo-positioning. An electronic magnetometer 1116 such as an integrated circuit chip could in turn be connected to peripherals interface 1106 to provide data related to the direction of true magnetic North whereby the mobile device could enjoy compass or directional functionality. Camera subsystem 1120 and an optical sensor 1122 such as a charged coupled device (CCD) or a complementary metal-oxide semiconductor (CMOS) optical sensor can facilitate camera functions such as recording photographs and video clips.

Communication functionality can be facilitated through one or more communication subsystems 1124, which may include one or more wireless communication subsystems. Wireless communication subsystems 1124 can include 802.5 or Bluetooth transceivers as well as optical transceivers such as infrared. Wired communication system can include a port device such as a Universal Serial Bus (USB) port or some other wired port connection that can be used to establish a wired coupling to other computing devices such as network access devices, personal computers, printers, displays, or other processing devices capable of receiving or transmitting data. The specific design and implementation of communication subsystem 1124 may depend on the communication network or medium over which the device is intended to operate. For example, a device may include wireless communication subsystem designed to operate over a global system for mobile communications (GSM) network, a GPRS network, an enhanced data GSM environment (EDGE) network, 802.5 communication networks, code division multiple access (CDMA) networks, or Bluetooth networks. Communication subsystem 1124 may include hosting protocols such that the device may be configured as a base station for other wireless devices. Communication subsystems can also allow the device to synchronize with a host device using one or more protocols such as TCP/IP, HTTP, or UDP.

Audio subsystem 1126 can be coupled to a speaker 1128 and one or more microphones 1130 to facilitate voice-enabled functions. These functions might include voice recognition, voice replication, or digital recording. Audio subsystem 1126 in conjunction may also encompass traditional telephony functions.

I/O subsystem 1140 may include touch controller 1142 and/or other input controller(s) 1144. Touch controller 1142 can be coupled to a touch surface 1146. Touch surface 1146 and touch controller 1142 may detect contact and movement or break thereof using any of a number of touch sensitivity technologies, including but not limited to capacitive, resistive, infrared, or surface acoustic wave technologies. Other pro5imity sensor arrays or elements for determining one or more points of contact with touch surface 1146 may likewise be utilized. In one implementation, touch surface 1146 can display virtual or soft buttons and a virtual keyboard, which can be used as an input/output device by the user.

Other input controllers 1144 can be coupled to other input/control devices 1148 such as one or more buttons, rocker switches, thumb-wheels, infrared ports, USB ports, and/or a pointer device such as a stylus. The one or more buttons (not shown) can include an up/down button for volume control of speaker 1128 and/or microphone 1130. In some implementations, device 1100 can include the functionality of an audio and/or video playback or recording device and may include a pin connector for tethering to other devices.

Memory interface 1102 can be coupled to memory 1150. Memory 1150 can include high-speed random access memory or non-volatile memory such as magnetic disk storage devices, optical storage devices, or flash memory. Memory 1150 can store operating system 1152, such as Darwin, RT5C, LINU5, UNI5, OS 5, ANDROID, WINDOWS, or an embedded operating system such as V5Works. Operating system 1152 may include instructions for handling basic system services and for performing hardware dependent tasks. In some implementations, operating system 1152 can include a kernel.

Memory 1150 may also store communication instructions 1154 to facilitate communicating with other mobile computing devices or servers. Communication instructions 1154 can also be used to select an operational mode or communication medium for use by the device based on a geographic location, which could be obtained by the GPS/Navigation instructions 1168. Memory 1150 may include graphical user interface instructions 1156 to facilitate graphic user interface processing such as the generation of an interface; sensor processing instructions 1158 to facilitate sensor-related processing and functions; phone instructions 1160 to facilitate phone-related processes and functions; electronic messaging instructions 1162 to facilitate electronic-messaging related processes and functions; web browsing instructions 1164 to facilitate web browsing-related processes and functions; media processing instructions 1166 to facilitate media processing-related processes and functions; GPS/Navigation instructions 1168 to facilitate GPS and navigation-related processes, camera instructions 1170 to facilitate camera-related processes and functions; and instructions 1172 for any other application that may be operating on or in conjunction with the mobile computing device. Memory 1150 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 1150 can include additional or fewer instructions. Furthermore, various functions of the mobile device may be implemented in hardware and/or in software, including in one or more signal processing and/or application specific integrated circuits.

Certain features may be implemented in a computer system that includes a back-end component, such as a data server, that includes a middleware component, such as an application server or an Internet server, or that includes a front-end component, such as a client computer having a graphical user interface or an Internet browser, or any combination of the foregoing. The components of the system can be connected by any form or medium of digital data communication such as a communication network. Some examples of communication networks include LAN, WAN and the computers and networks forming the Internet. The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an API that can define on or more parameters that are passed between a calling application and other software code such as an operating system, library routine, function that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, and communications capability.

Methods may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps described herein (and the order thereof) are exemplary and may include various alternatives, equivalents, or derivations thereof including but not limited to the order of execution of the same.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method of color matching for health management, the method comprising:
storing information regarding a plurality of colors in memory of a user device, each color associated with a pH level;
storing one or more patient records in memory, wherein each patient record comprises a pH level for each of a plurality of samples from a patient over time;
receiving via a communication interface an electronic indication regarding a color associated with a sample from an identified patient;
executing instructions stored in memory, wherein execution of the instructions by a processor:
compares the received electronic indication regarding the color with the stored information in memory regarding the plurality of colors,
identifies a closest match between the received electronic indication and one of the plurality of colors in memory,
determines a pH level associated with the closest matching color, and
updates a patient record associated with the identified patient of the received electronic indication, wherein the updated patient record includes the determined pH level and the closest matching color.

2. The method of claim 1, further comprising generating a visual report regarding a plurality of pH levels associated with the updated patient record.

3. The method of claim 2, wherein the visual report is a table listing the plurality of pH levels, each pH level associated with a date and a time of day.

4. The method of claim 2, wherein the visual report is a graph plotting the plurality of pH levels over a period of time.

5. The method of claim 1, wherein receiving the electronic indication regarding the color comprises capturing a digital photograph.

6. The method of claim 5, further comprising:
determining that the digital photograph includes a plurality of colors;
generating a prompt to the user to select one of the plurality of colors; and
receiving a selection from the user via a user interface, wherein the selection indicates one of the plurality of colors in the digital photograph.

7. The method of claim 1, wherein receiving the electronic indication regarding the color comprises generating a color wheel and receiving a color selection from the user indicating one of the colors on the color wheel.

8. The method of claim 1, further comprising updating a display of the user device in real-time, wherein the updated display indicates the determined pH level.

9. The method of claim 1, further comprising synchronizing the updated patient report with a designated cloud server, wherein the synchronization occurs over a communication network.

10. An apparatus of color matching for health management, the apparatus comprising:
memory that stores:
information regarding a plurality of colors, each color associated with a pH level;
one or more patient records, wherein each patient record comprises a pH level for each of a plurality of samples from a patient over time;
a communication interface that receives an electronic indication regarding a color associated with a sample from the patient; and
a processor that executes instructions stored in memory, wherein execution of the instructions by the processor:
compares the received electronic indication regarding the color with the stored information in memory regarding the plurality of colors,
identifies a closest match between the received electronic indication and one of the plurality of colors in memory,
determines a pH level associated with the closest matching color, and
updates a patient record associated with the received electronic indication, wherein the updated patient record includes the determined pH level and the closest matching color.

11. The apparatus of claim 10, further comprising a display screen that displays a visual report regarding a plurality of pH levels associated with the updated patient record.

12. The apparatus of claim 11, wherein the visual report is a table listing the plurality of pH levels, each pH level associated with a date and a time of day.

13. The apparatus of claim 11, wherein the visual report is a graph plotting the plurality of pH levels over a period of time.

14. The apparatus of claim 10, further comprising a digital camera, wherein the electronic indication regarding the color comprises a digital photograph captured by the digital camera.

15. The apparatus of claim 14, wherein the processor executes further instructions to:
determine that the digital photograph includes a plurality of colors; and
generate a prompt to the user to select one of the plurality of colors, and further comprising a user interface that receives a selection from the user, wherein the selection indicates one of the plurality of colors in the digital photograph.

16. The apparatus of claim 10, further comprising a display screen that displays a color wheel and a user interface that receives a color selection from the user indicating one of the colors on the color wheel.

17. The apparatus of claim 10, wherein the processor executes further instructions to update a display of the user device in real-time, wherein the updated display indicates the determined pH level.

18. The apparatus of claim 10, wherein the communication interface synchronizes the updated patient report with a designated cloud server, wherein the synchronization occurs over a communication network.

19. A non-transitory computer-readable storage medium, having embodied thereon a program executable by a processor to perform a method of color matching for health management, the method comprising:
storing information regarding a plurality of colors, each color associated with a pH level;
storing one or more patient records, wherein each patient record comprises pH of samples from a patient over time;
receiving via a communication interface an electronic indication regarding a color associated with a sample from the patient;
comparing the received electronic indication regarding the color with the stored information in memory regarding the plurality of colors;
identifying a closest match between the received electronic indication and one of the plurality of colors in memory;
determining a pH associated with the closest matching color; and
updating a patient record associated with the received electronic indication, wherein the updated patient record includes the determined pH and the closest matching color.
